(19) United States
(12) Patent Application Publication
(10) Pub. No.: US 2026/0301225 A1
(43) Pub. Date: Oct. 1, 2026

(54) INFORMATION PROCESSING APPARATUS, INFORMATION PROCESSING SYSTEM, METHOD OF CONTROLLING INFORMATION PROCESSING APPARATUS, AND MEDIUM

(71) Applicant: CANON KABUSHIKI KAISHA, Tokyo (JP)

(72) Inventor: Nozomu KASUYA, Kanagawa (JP)

(21) Appl. No.: 19/574,517

(22) Filed: Mar. 23, 2026

(30) Foreign Application Priority Data
Mar. 27, 2025 (JP) 2025-053750

(51) Int. Cl. G06T 7/80; H04N 13/111; H04N 13/282; H04N 13/296; H04N 23/68

(52) U.S. Cl. CPC G06T 7/80; H04N 13/111; H04N 13/282; H04N 13/296; H04N 23/6811; H04N 23/683; G06T 2207/30244

(57) ABSTRACT

An information processing apparatus is provided. The apparatus obtains a captured image of a feature captured by an image capturing apparatus. The apparatus generates information indicating shake in the image capturing apparatus. The shake is estimated based on the captured image. The apparatus generates, based on the captured image and the information indicating the shake in the image capturing apparatus, position information indicating a position of the feature in a field of view of the image capturing apparatus. An influence of the shake in the image capturing apparatus is reduced in the position information. The apparatus calculates, for each of a plurality of image capturing apparatuses, a camera parameter of the image capturing apparatus based on the position information indicating the position of the feature for the image capturing apparatus.

### BACKGROUND

### Field of the Technology

The present disclosure relates to an information processing apparatus, an information processing system, a control method, and a medium, and particularly relates to a technique for generating a virtual viewpoint image.

### Description of the Related Art

Techniques for generating virtual viewpoint images are attracting attention. Such techniques for generating virtual viewpoint images make it possible for video producers to create content from an eye-catching viewpoint among a variety of viewpoints, including viewpoints that thus far could not be captured by cameras.

A virtual viewpoint image can be generated using images from a plurality of viewpoints. Each image is obtained by synchronously capturing images using a plurality of image capturing apparatuses installed at different positions. Geometric parameters such as the positions and orientations, focal lengths, and the like of the image capturing apparatuses are also used to generate the virtual viewpoint images. Calibration operations are therefore performed to obtain these parameters more accurately in advance, such as when the image capturing apparatuses are installed.

Japanese Patent Laid-Open No. 2014-89168 discloses a calibration method for an image capturing apparatus. According to the technique described in Japanese Patent Laid-Open No. 2014-89168, a plurality of image capturing apparatuses capture images while a sphere of a known diameter is moved in a target space. The image capturing apparatuses are then calibrated based on the positions and sizes of the sphere in the images.

The position or orientation of an image capturing apparatus may also change due to vibrations during calibration. Japanese Patent Laid-Open No. 2019-190974 discloses a technique for calibrating an image capturing apparatus based on a captured image obtained at a timing when vibration of the image capturing apparatus is within an acceptable value.

An image capturing apparatus may shake such that the position or orientation of the image capturing apparatus changes during calibration, such as when the image capturing apparatus is installed in an outdoor, high-wind environment. It has therefore been difficult to calibrate image capturing apparatuses accurately.

### SUMMARY

According to an embodiment of the present disclosure, an information processing apparatus comprises one or more memories storing instructions and one or more processors that execute the instructions to: obtain a captured image of a feature captured by an image capturing apparatus; generate information indicating shake in the image capturing apparatus, the shake being estimated based on the captured image; generate, based on the captured image and the information indicating the shake in the image capturing apparatus, position information indicating a position of the feature in a field of view of the image capturing apparatus, an influence of the shake in the image capturing apparatus being reduced in the position information; and calculate, for each of a plurality of image capturing apparatuses, a camera parameter of the image capturing apparatus based on the position information indicating the position of the feature for the image capturing apparatus.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram illustrating an example of the configuration of an image generation system according to one embodiment.

FIG. 2 is a diagram illustrating an example of the hardware configuration of a calibration apparatus according to one embodiment.

FIG. 3 is a diagram illustrating an example of the functional configuration of the image generation system according to one embodiment.

FIG. 4 is a diagram illustrating an example of a flowchart of an information processing method according to one embodiment.

FIG. 5 is a diagram illustrating an example of a flowchart of a shake estimation method according to one embodiment.

FIG. 6 is a diagram illustrating an example of the functional configuration of the calibration apparatus according to one embodiment.

### DESCRIPTION OF THE EMBODIMENTS

Embodiments will be described hereinafter in detail, with reference to the accompanying drawings. Note that the following embodiments do not limit the scope of patent claims. Although several features are described in the embodiments, all of these features are not necessarily required, and multiple features may be combined as desired. Furthermore, in the accompanying drawings, the same or similar configurations are given the same reference numerals, and redundant descriptions thereof will be omitted.

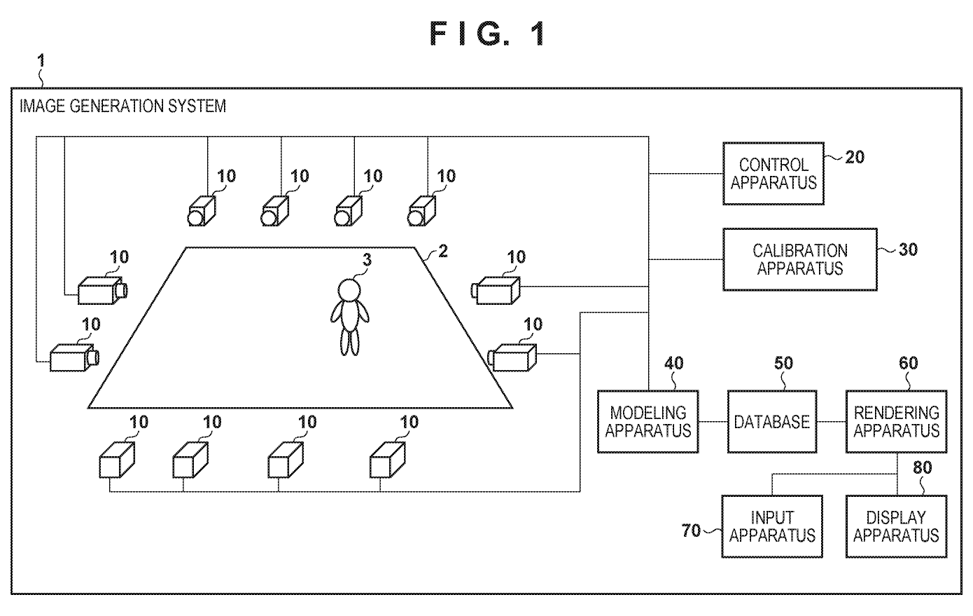

FIG. 1 illustrates an example of an image generation system 1 for generating a virtual viewpoint image, which is an information processing system according to one embodiment. The image generation system 1 includes a plurality of image capturing apparatuses 10, a control apparatus 20, a calibration apparatus 30, a modeling apparatus 40, a database 50, a rendering apparatus 60, an input apparatus 70, and a display apparatus 80.

Each of the plurality of image capturing apparatuses 10 captures an image of an object 3 within a shooting target area 2. The captured image captured by the image capturing apparatus 10 is sent to the modeling apparatus 40. The modeling apparatus 40 generates three-dimensional information expressing a three-dimensional shape of the object 3. The three-dimensional information can, for example, be point cloud data expressing the three-dimensional shape of the object 3. The modeling apparatus 40 can generate the three-dimensional information through a visual hull method, for example. The modeling apparatus 40 then stores the three-dimensional information in the database 50 along with the captured image captured by the image capturing apparatus.

The rendering apparatus 60 generates a virtual viewpoint image using the three-dimensional information and the captured images stored in the database 50. The rendering apparatus 60 can generate the virtual viewpoint image based on virtual viewpoint information specifying a virtual viewpoint input from the input apparatus 70. The virtual viewpoint information can indicate the position and orientation of the virtual viewpoint, angle of view information such as the focal length, and the time of a rendering target. The display apparatus 80 displays the virtual viewpoint image generated by the rendering apparatus 60.

The control apparatus 20 can control other apparatuses. For example, the control apparatus 20 can control each of the plurality of image capturing apparatuses 10 to capture images. The plurality of image capturing apparatuses 10 can capture images at timings controlled by the control apparatus 20.

For the image generation system 1 to generate a virtual viewpoint image, the image capturing apparatuses 10 are calibrated in advance. In the calibration processing, camera parameters of each image capturing apparatus 10 are calculated. The camera parameters can indicate the position and orientation and the focal length of the image capturing apparatus 10, for example. The modeling apparatus 40 can generate the three-dimensional information by referring to such camera parameters. The calibration apparatus 30 calibrates the image capturing apparatuses 10 in this manner.

The calibration apparatus 30 can perform the calibration processing using a plurality of captured images obtained by each of the plurality of image capturing apparatuses 10 capturing a common feature. Each of the plurality of captured images is an image captured by a different one of the image capturing apparatuses 10. Additionally, each of the plurality of captured images can be obtained by the plurality of image capturing apparatuses 10 capturing the common feature in synchronization. This feature can be arranged at various positions within the shooting target area 2. In one embodiment, the plurality of image capturing apparatuses 10 capture a moving feature in synchronization. In other words, the plurality of image capturing apparatuses can capture images in synchronization, at each of a plurality of timings at which the position of the feature is different. However, the plurality of image capturing apparatuses may capture one or more features that are at rest, either simultaneously or sequentially.

A marker is used as the feature for calibration in the present embodiment. The marker has an identifier. The identifier can be a QR code (registered trademark), for example. Detecting the identifier from the captured image makes it possible to detect that a specific marker is located at a specific position in the captured image.

The calibration apparatus 30, which is an information processing apparatus according to one embodiment, will be described hereinafter. The calibration apparatus 30 can be implemented by a computer including a processor and a memory. Note that the calibration apparatus 30 according to one embodiment may be constituted by a plurality of information processing apparatuses connected over a network, for example.

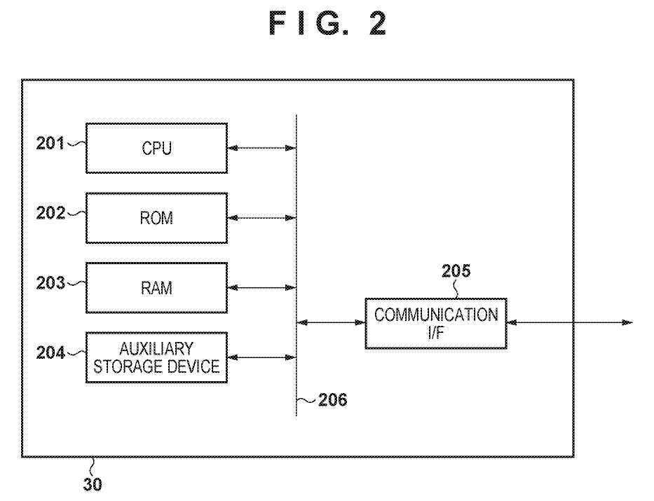

FIG. 2 is a block diagram illustrating an example of the hardware configuration of a computer that can be used as the calibration apparatus 30, which is an information processing apparatus according to one embodiment. The calibration apparatus 30 includes a CPU 201, a ROM 202, a RAM 203, an auxiliary storage device 204, a communication I/F 205, and a bus 206. The CPU 201 controls the calibration apparatus 30 as a whole based on computer programs or data stored in the ROM 202 or the RAM 203.

The ROM 202 is a memory that stores programs and the like that do not need to be changed. The RAM 203 is a memory that temporarily stores programs or data. The programs and data can be supplied from the auxiliary storage device 204. The programs and data can also be supplied from outside the calibration apparatus 30 through the communication I/F 205. The auxiliary storage device 204 is storage such as a hard disk drive, for example. The auxiliary storage device 204 can store various types of data, such as image data or audio data.

The communication I/F 205 is an interface for communication with apparatuses outside the calibration apparatus 30. For example, if the calibration apparatus 30 is connected to an external apparatus by a wire, a communication cable is connected to the communication I/F 205. If the calibration apparatus 30 communicates with external apparatuses wirelessly, the communication I/F 205 has an antenna. The bus 206 transmits information among the various units of the calibration apparatus 30.

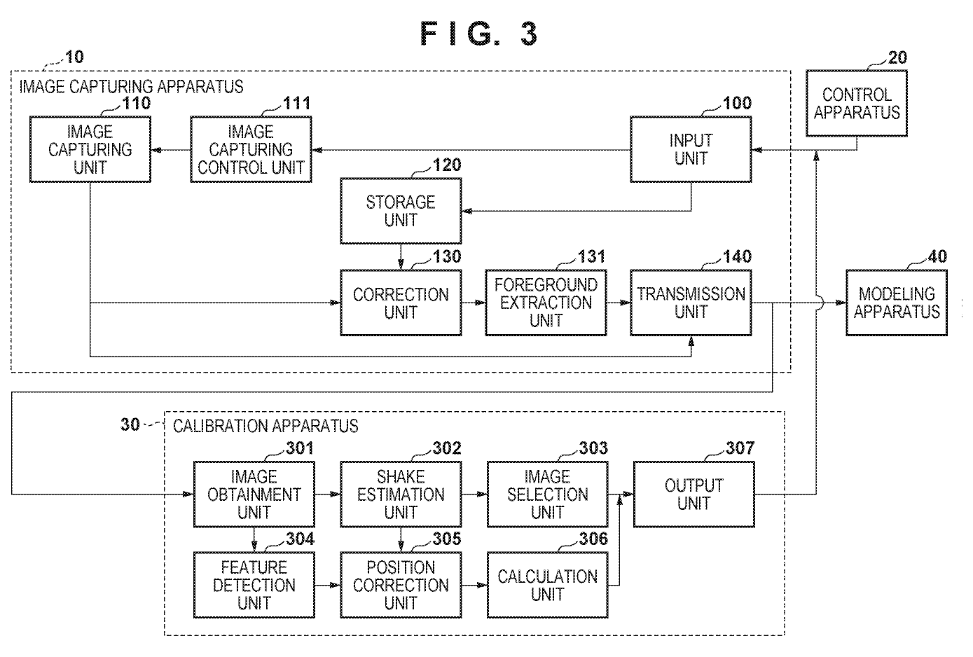

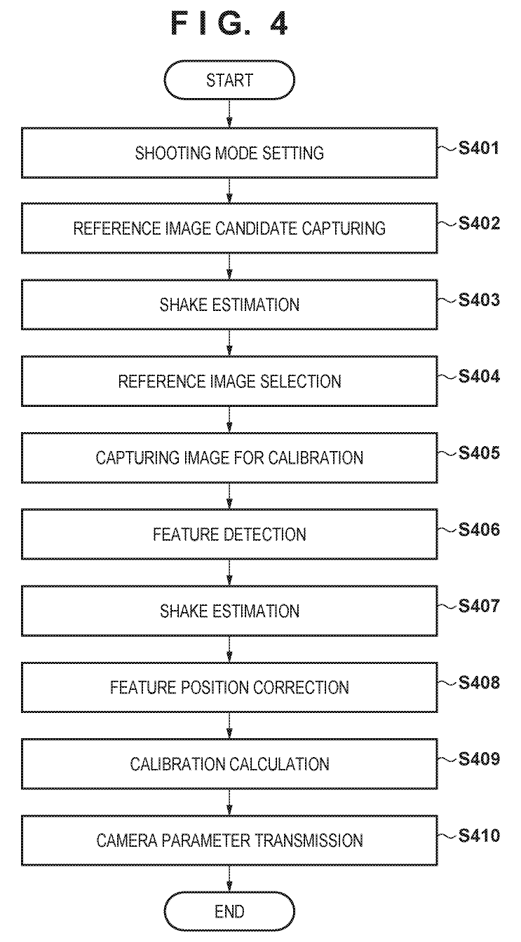

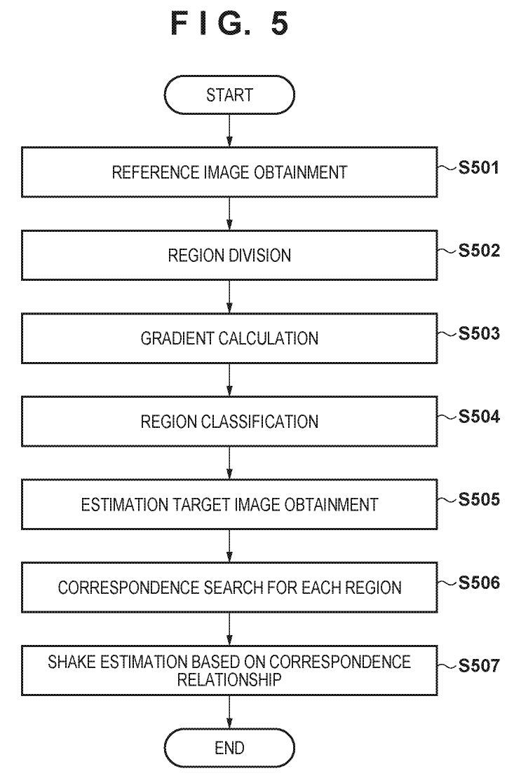

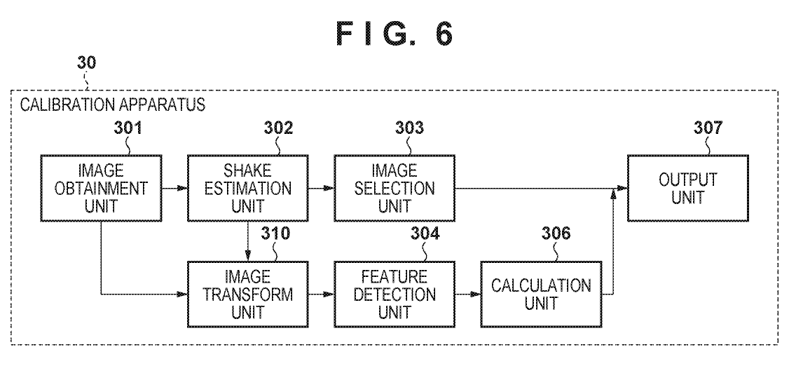

In this manner, by a processor such as the CPU 201 executing control programs stored in the ROM 202 and read out to the RAM 203, the functions of the various units of the calibration apparatus 30, illustrated in FIGS. 3, 6, and the like and described later, can be implemented. In addition, the processing illustrated in FIGS. 4, 5, and the like can be implemented by a processor such as the CPU 201 executing control programs stored in the ROM 202 and read out to the RAM 203. The CPU 201 need not implement the functions of all the processing units. For example, the calibration apparatus 30 may include one or more items of dedicated hardware different from the CPU 201. In this case, the calibration apparatus 30 may have a processing circuit corresponding to one or more processing units. An application-specific integrated circuit (ASIC), a field-programmable gate array (FPGA), a digital signal processor (DSP), and the like can be given as examples of such dedicated hardware.

The image capturing apparatus 10, too, can be implemented using at least one of a computer including a processor and a memory, and dedicated hardware (e.g., an optical system and an image sensor). For example, the functions of the various units of the image capturing apparatus 10, illustrated in FIGS. 3, 6, and the like and described later, can be implemented by a processor such as the CPU 201 included in the image capturing apparatus 10, or by dedicated hardware.

Other apparatuses constituting the image generation system 1, such as the modeling apparatus 40, can also be implemented by a computer including a processor and a memory. Note that the other apparatuses constituting the image generation system 1, such as the modeling apparatus 40, may be constituted by a plurality of information processing apparatuses connected over a network, for example.

The position or orientation of the image capturing apparatus 10 may change due to the influence of vibrations, as described above. Vibrations during calibration in particular cause error in the camera parameters obtained through the calibration. The accuracy of the calibration may therefore drop due to the influence of vibrations. In this case, the accuracy of the three-dimensional information of the object generated by the modeling apparatus 40 based on the camera parameters may drop, and the shape of the object, for example, may be partially lost. In the present embodiment, a shake reduction mechanism is incorporated into the calibration apparatus 30. In the present embodiment, the image capturing apparatus can be calibrated with a higher level of accuracy, even in situations where vibrations occur, which makes it possible to generate a virtual viewpoint image with a higher level of accuracy as well.

The functions of and processing performed by the image capturing apparatus 10 and the calibration apparatus 30 according to the present embodiment will be described hereinafter with reference to the function block diagram illustrated in FIG. 3 and the flowchart illustrated in FIG. 4. The image capturing apparatus 10 includes an input unit 100, an image capturing unit 110, an image capturing control unit 111, a storage unit 120, a correction unit 130, a foreground extraction unit 131, and a transmission unit 140.

The input unit 100 receives control commands from the control apparatus 20. The input unit 100 then transmits control commands to the image capturing control unit 111. The control commands can include a command specifying an image capturing mode, for example. The control commands can also include a command for capturing an image. The input unit 100 also receives a reference image from the calibration apparatus 30. The reference image is used by the correction unit 130 for correcting the captured image. The correction unit 130 stores the received reference image in the storage unit 120.

The image capturing unit 110 captures an image under the control of the image capturing control unit 111. The image capturing unit 110 then supplies the captured image obtained by the image capturing to the correction unit 130 or the transmission unit 140. The image capturing control unit 111 can control the destination to which the captured image is to be supplied.

The image capturing control unit 111 controls the image capturing unit 110 in accordance with commands supplied from the input unit 100. The image capturing control unit 111 can also set a shooting mode of the image capturing apparatus 10. The image capturing apparatus 10 can operate in a calibration shooting mode or a virtual viewpoint image shooting mode. In the calibration shooting mode, the image capturing unit 110 supplies the captured image to the transmission unit 140 as-is. Additionally, the transmission unit 140 transmits the captured image to the calibration apparatus 30. On the other hand, in the virtual viewpoint image shooting mode, the image capturing unit 110 supplies the captured image to the correction unit 130. At this time, the transmission unit 140 transmits a foreground image generated by the correction unit 130 and the foreground extraction unit 131 to the modeling apparatus 40.

The correction unit 130 corrects the captured image captured by the image capturing unit 110 to reduce the influence of shake in the image capturing apparatus 10. For example, the correction unit 130 obtains an image captured by the image capturing unit 110. The correction unit 130 can then correct the captured image to cancel the influence of vibrations in the image capturing apparatus 10 itself. In one embodiment, the correction unit 130 can correct the captured image based on a comparison with the reference image stored in the storage unit 120 and supplied from the calibration apparatus 30. For example, the correction unit 130 can cancel the influence of shake by transforming the captured image to more closely resemble the reference image.

In one embodiment, the correction unit 130 calculates a homography transform between the captured image and the reference image through the same method as that used by a shake estimation unit 302 (described later). The captured image can then be transformed by applying the calculated homography transform to the captured image.

The foreground extraction unit 131 extracts a foreground part from the captured image corrected by the correction unit 130. The foreground extraction unit 131 can extract a foreground region using a background difference method, for example. This enables the foreground extraction unit 131 to extract a region corresponding to the object 3 from the captured image. The foreground extraction unit 131 supplies an image of the extracted foreground region to the transmission unit 140.

In the calibration shooting mode, the transmission unit 140 transmits the captured image supplied from the image capturing unit 110 to the calibration apparatus 30. In the virtual viewpoint image shooting mode, the transmission unit 140 supplies the foreground image supplied from the foreground extraction unit 131 to the modeling apparatus 40.

Note that in one embodiment, the reference image expresses a captured image captured by the image capturing apparatus 10 in a reference pose (described later). Accordingly, the captured image of the object 3 captured by the image capturing apparatus 10 in the reference pose can be estimated by transforming the captured image to include an image that matches the reference image. The foreground image that is based on the captured image transformed in this manner is sent from the image capturing apparatus 10 to the modeling apparatus 40. As will be described later, the camera parameters of the image capturing apparatus 10 in the reference pose obtained through the calibration are sent from the calibration apparatus 30 to the modeling apparatus 40. Accordingly, the modeling apparatus 40 can generate the three-dimensional information of the object 3 based on the camera parameters of the image capturing apparatus 10 in the reference pose and the image of the object 3 captured by the image capturing apparatus 10 in the reference pose. The modeling apparatus 40 can therefore generate the three-dimensional information of the object 3 based on the camera parameters in which the influence of shake in the image capturing apparatus 10 has been reduced and the image of the object 3. This makes it possible to improve the accuracy of the three-dimensional information of the object 3. Herein, the “pose” (or “reference pose”) of the image capturing apparatus 10 represents the orientation of the optical axis of the image capturing apparatus 10. However, the “pose” of the image capturing apparatus 10 may represent the position of the image capturing apparatus 10 in addition to the orientation of the optical axis of the image capturing apparatus 10.

The calibration apparatus 30 includes an image obtainment unit 301, the shake estimation unit 302, an image selection unit 303, a feature detection unit 304, a position correction unit 305, a calculation unit 306, and an output unit 307. The image obtainment unit 301 obtains a captured image captured by the image capturing apparatus 10 and transmitted from the image capturing apparatus 10. Each of the image capturing apparatuses 10 can capture an image of the shooting target area 2. A feature for calibration, such as a marker, can be arranged in the shooting target area 2. Accordingly, the image obtainment unit 301 can obtain a captured image of the feature captured by the image capturing apparatus 10. However, the image obtainment unit 301 can also obtain a captured image that does not include the feature for calibration. An example of the captured image used in each instance of processing will be given later. The image obtainment unit 301 can obtain a captured image from each of the plurality of image capturing apparatuses 10. The image obtainment unit 301 can also obtain a plurality of captured images from a single image capturing apparatus 10. The image obtainment unit 301 supplies the obtained captured image to the shake estimation unit 302 and the feature detection unit 304.

The shake estimation unit 302 generates information indicating shake in the image capturing apparatus 10, estimated based on the captured image. The shake estimation unit 302 can generate the information indicating shake in a given one of the image capturing apparatuses 10 based on a comparison of a plurality of captured images captured by that one image capturing apparatus 10. The shake in captured images captured by the image capturing apparatus 10 shows the shake in the image capturing apparatus 10. Accordingly, the information indicating shake in captured images captured by the image capturing apparatus 10 can also be used as the information indicating shake in the image capturing apparatus 10. An example of the information indicating shake in the image capturing apparatus 10 is an amount of shift between two captured images. Another example of the information indicating shake in the image capturing apparatus 10 is a transformation parameter for aligning two captured images. This transformation parameter can be a parameter of a homography transform, for example.

In one embodiment, the shake estimation unit 302 generates the information indicating shake in the image capturing apparatus 10 based on a comparison between the reference image and a captured image to be processed. The reference image corresponds to a field of view when the image capturing apparatus 10 is in the reference pose. In other words, the reference image indicates a captured image captured by the image capturing apparatus 10 in the reference pose. The captured image to be processed is the captured image obtained by the image capturing apparatus 10 at a timing for estimation. In this case, the shake estimation unit 302 can generate the information indicating the shake in the image capturing apparatus 10, indicating a change in the pose of the image capturing apparatus 10 or an amount thereof at the timing for estimation, relative to the reference pose of the image capturing apparatus 10. For example, the information indicating shake in the image capturing apparatus 10 can be an amount by which the captured image to be processed has shifted from the reference image, or a transformation parameter for aligning the captured image to be processed with the reference image.

The shake estimation unit 302 can generate the information indicating shake in the image capturing apparatus 10 for each of the plurality of image capturing apparatuses 10. The shake estimation unit 302 can also generate the information indicating shake in a given one of the image capturing apparatuses 10 corresponding to each of a plurality of captured images obtained by that one image capturing apparatus 10. The “information indicating shake in the image capturing apparatus 10 corresponding to the captured image” refers to information indicating shake in the image capturing apparatus 10 at the timing at which the captured image was captured. A method for determining the reference image will be described later.

The image selection unit 303 determines the reference image for a single image capturing apparatus 10 based on a plurality of images obtained by that one image capturing apparatus 10. The image selection unit 303 can determine the reference image based on the information indicating shake in the image capturing apparatus 10 corresponding to each of the plurality of images. For example, the image selection unit 303 can select the reference image from among a plurality of images based on the information indicating shake in the image capturing apparatus 10. In the present embodiment, the image selection unit 303 selects, as the reference image, a captured image captured by the image capturing apparatus 10 when the pose of the image capturing apparatus 10 is closer to the center of shake in the image capturing apparatus 10 estimated using each of the plurality of images. The reference image obtained in this manner is expected to be similar to a captured image obtained by the image capturing apparatus 10 that is not shaking. The image selection unit 303 supplies the determined reference image to the output unit 307.

The feature detection unit 304 and the position correction unit 305 generate position information indicating the position of a feature in the field of view of the image capturing apparatus 10, with the influence of the shake in the image capturing apparatus 10 reduced, based on the captured image and the information indicating shake in the image capturing apparatus 10.

In the present embodiment, the feature detection unit 304 detects the feature from the captured image. In the present embodiment, the feature detection unit 304 can detect the marker from the captured image supplied from the image obtainment unit 301. The feature detection unit 304 can also identify the marker based on the identifier of the marker. The feature detection unit 304 can detect a position in the captured image where a specific marker is present accurately to the level of sub-pixels.

The position correction unit 305 corrects the position of the feature detected by the feature detection unit 304 based on the information indicating shake in the image capturing apparatus 10. The position correction unit 305 can correct the position of the feature detected from the captured image to be processed, obtained by the image capturing apparatus 10, based on the information indicating shake in the image capturing apparatus 10 corresponding to the captured image to be processed. In one embodiment, a homography transform according to the information indicating shake in the image capturing apparatus 10 can be applied to coordinates indicating the detected position of the feature. For example, the position correction unit 305 can apply, to the coordinates indicating the detected position of the feature, the inverse transform of the homography transform that transforms the reference image to the captured image. In this manner, the position correction unit 305 can transform the position of the feature detected from the captured image to be processed to the position of the feature in the reference image. The post-transform position of the feature indicates the position of the feature in the field of view when the image capturing apparatus 10 is in the reference pose. In other words, the post-transform position of the feature indicates an estimated position of the same feature in the captured image obtained when the image capturing apparatus 10 is in the reference pose. Such processing makes it possible to remove the influence of shake in the image capturing apparatus 10 from the result of detecting the position of the feature that is based on the captured image captured by the image capturing apparatus 10.

The calculation unit 306 calculates the camera parameters of the plurality of image capturing apparatuses 10 based on position information indicating the position of the feature for each of the plurality of image capturing apparatuses 10. The position information represents the position of the feature corrected by the position correction unit 305. In other words, the position information can indicate the position of the feature in the field of view when the corresponding image capturing apparatus 10 is in the reference pose.

The calculation unit 306 can calculate the camera parameters using a calibration method of any desired one of the image capturing apparatuses 10. The types of the camera parameters calculated are not particularly limited. For example, the calculation unit 306 can calculate external parameters indicating at least one of the position and the orientation of the image capturing apparatus 10. The calculation unit 306 can also calculate internal parameters indicating at least one of the focal length and the image center of the image capturing apparatus 10. The calculation unit 306 can also calculate distortion parameters of the image capturing apparatus 10.

The output unit 307 outputs the reference image selected by the image selection unit 303 to the image capturing apparatus 10. The output unit 307 also outputs the camera parameters calculated by the calculation unit 306 to the image capturing apparatus 10 and the modeling apparatus 40.

FIG. 4 is a flowchart illustrating processing performed by the image generation system 1 according to the present embodiment. The image generation system 1 calibrates the plurality of image capturing apparatuses 10 through the processing illustrated in FIG. 4. A control method of the calibration apparatus 30 according to one embodiment includes the processing of steps S403 to S410.

In step S401, the image capturing control unit 111 of the image capturing apparatus 10 sets the shooting mode of the image capturing apparatus 10. For example, the control apparatus 20 can send a shooting mode setting instruction to the image capturing apparatus 10. The input unit 100 receives the shooting mode setting instruction and sends the setting instruction to the image capturing control unit 111. The image capturing control unit 111 can set the shooting mode in accordance with the setting instruction. In this example, the image capturing apparatus 10 sets the shooting mode to the calibration shooting mode in accordance with the setting instruction. As mentioned earlier, in the calibration shooting mode, the image capturing unit 110 sends the captured image to the transmission unit 140 as-is without the captured image passing through the correction unit 130 and the foreground extraction unit 131.

In step S402, the image capturing apparatus 10 generates a reference image candidate group by capturing images. For example, the control apparatus 20 can send an image capturing instruction to the image capturing apparatus 10. The image capturing instruction can instruct the image capturing apparatus 10 to capture an image a plurality of times. The input unit 100 receives the image capturing instruction and sends the image capturing instruction to the image capturing control unit 111. The image capturing control unit 111 controls the image capturing unit 110 to generate the reference image candidate group constituted by a plurality of captured images obtained by capturing images a plurality of times. Additionally, the transmission unit 140 receives the reference image candidate group from the image capturing unit 110 and transmits the reference images to the calibration apparatus 30. The reference image candidate group is a group of candidates for the reference image to be used by the correction unit 130 later.

Note that in step S402, it is not necessary for the plurality of image capturing apparatuses 10 to capture images in synchronization. In other words, the plurality of image capturing apparatuses 10 can capture images at different timings.

In step S403, the shake estimation unit 302 of the calibration apparatus 30 estimates shake in the image capturing apparatus 10. For example, the image obtainment unit 301 obtains the reference image candidate group from the transmission unit 140 of the image capturing apparatus 10. The shake estimation unit 302 then generates the information indicating shake in the image capturing apparatus 10, corresponding to the corresponding reference image candidate group. The method for estimating the shake will be described in detail later with reference to FIG. 5.

Note that the reference image has not yet been determined at this point in time. The shake estimation unit 302 can use one image from the reference image candidate group as a provisional reference image. For example, taking the first reference image candidate obtained by the image capturing apparatus 10 as a reference, the shake estimation unit 302 can estimate the information indicating shake in the image capturing apparatus 10 corresponding to the second and subsequent reference image candidates. In other words, the shake estimation unit 302 can generate the information indicating the change in the pose of the image capturing apparatus 10 or the amount thereof at the timing at which each of the reference image candidates was captured, relative to the pose of the image capturing apparatus 10 at the timing at which the first reference image candidate was captured. For example, the shake estimation unit 302 can calculate the amount of shift from the first reference image candidate for each of the reference image candidates, or can calculate the transform parameters for aligning each of the reference image candidates with the first reference image candidate.

In step S404, the image selection unit 303 determines the reference image for the image capturing apparatus 10 based on the information indicating shake in the image capturing apparatus 10 estimated in step S403. The image selection unit 303 can select the image, among the reference image candidate group, captured by the image capturing apparatus 10 at the timing closest to the center of the shake, as the reference image. The provisional reference image referred to in step S403 is not necessarily the image captured by the image capturing apparatus 10 at the timing closest to the center of the shake. Accordingly, the image selection unit 303 can obtain statistics of the amount of shake that are based on the information indicating shake in the image capturing apparatus 10 calculated by the shake estimation unit 302. The image selection unit 303 can then select the reference image from the reference image candidate group based on the statistics of the amount of shake. As a specific example, the image selection unit 303 can calculate a median value of the amount of shake indicated by the information indicating shake in the image capturing apparatus 10 corresponding to each of the images in the reference image candidate group. The image selection unit 303 can then select, as the reference image, the reference image candidate corresponding to the information indicating shake in the image capturing apparatus 10 that indicates an amount of shake closest to the median value. In this manner, using a configuration in which the reference image is selected based on the median value of the amount of shake, the amount of correction by the position correction unit 305 and the correction unit 130 is expected to be reduced, and the accuracy of the correction improved.

However, the image selection unit 303 may generate the reference image by compositing reference image candidates. For example, the image selection unit 303 can perform weighted compositing of a plurality of reference image candidates based on the amount of shake indicated by the information indicating shake in the image capturing apparatus 10 corresponding to the reference image candidates. At this time, a greater weight can be applied as the difference between the amount of shake and the median value of the amount of shake drops.

The method for evaluating the amount of shake in step S404 is not particularly limited. For example, in step S403, the shake estimation unit 302 can calculate a homography transform between a first image and a second image. This processing will be described later with reference to FIG. 5. At this time, the image selection unit 303 can evaluate the amount by which the pose of the image capturing apparatus 10, at the timing at which the second image was captured, has changed from the timing at which the first image was captured, based on the homography transform and the internal parameters of the image capturing apparatus 10. The amount of change in the pose can be, for example, an amount of rotation in roll, pitch, and yaw directions. This amount of change in the pose can be used as the amount of shake corresponding to the second image. The image selection unit 303 can similarly evaluate the amount by which the pose of the image capturing apparatus 10, at the timing at which each reference image candidate was captured, has changed from the timing at which the first image was captured, as the amount of shake corresponding to that reference image candidate. The image selection unit 303 can then determine the median value of the amounts of shake corresponding to the reference image candidates as the median value of the shake. The image selection unit 303 can also select the reference image from the reference image candidate group to minimize a difference between the amount of change in the pose of the image capturing apparatus 10 at the timing at which the reference image was captured and the median value of the amount of change in the pose. Here, the difference between the amount of change in the pose and the median value can be expressed as the sum of the difference between the amount of change in the pose and the median value for each of roll, pitch, and yaw components.

As another method, in step S403, the shake estimation unit 302 can calculate an amount of shift of the image for each of divided regions. This processing will be described later with reference to steps S501 to S506 of FIG. 5. At this time, the image selection unit 303 can use an integrated value of the amount of shift of the image for each of the divided regions as the amount of shake corresponding to the reference image candidate. In this case too, the image selection unit 303 can select the reference image from the reference image candidate group to minimize the difference between the amount of shake evaluated for the reference image and the median value of the amount of shake evaluated for the reference image candidate group.

As yet another method, the image selection unit 303 may select, as the reference image, a reference image candidate determined to have been captured in a period of little shake in the image capturing apparatus 10, based on each of the reference image candidates. The period of little shake in the image capturing apparatus 10 may be a period in which variation in the amount of shake evaluated as described above is no greater than a threshold. In addition, it is not necessary to select the reference image from the reference image candidate group based on the amount of shake. Any captured image captured by the image capturing apparatus 10 may be used as the reference image.

The processing of steps S401 to S404 is performed for each of the plurality of image capturing apparatuses 10. In other words, each of the plurality of image capturing apparatuses 10 obtains a reference image candidate group by capturing images. The calibration apparatus 30 then determines the reference image for each of the image capturing apparatuses 10.

In step S405, the plurality of image capturing apparatuses 10 capture images in synchronization, at each of a plurality of timings at which the position of the feature is different. In the present embodiment, an object having a marker for calibration moves within the shooting target area 2. The control apparatus 20 then sends image capturing instructions to the plurality of image capturing apparatuses 10 while the object is moving. In this manner, the plurality of image capturing apparatuses 10 capture a plurality of images in synchronization. Each image capturing apparatus 10 therefore obtains a plurality of captured images in which the marker is displayed at different positions. Each of the captured images captured by the image capturing apparatus 10 is sent to the calibration apparatus 30 and obtained by the image obtainment unit 301.

In step S406, the feature detection unit 304 detects the feature from each of the captured images obtained in step S405. In the present embodiment, the feature detection unit 304 detects the marker accurately to the level of sub-pixels.

In step S407, the shake estimation unit 302 generates the information indicating shake in the image capturing apparatus 10, estimated based on each of the captured images obtained in step S405. The shake estimation unit 302 can generate the information indicating shake in the image capturing apparatus 10 corresponding to the respective captured images through the method described later with reference to FIG. 5. In the present embodiment, the shake estimation unit 302 calculates the transformation parameters for aligning the captured image to be processed with the reference image as the information indicating shake in the image capturing apparatus 10 corresponding to the captured image to be processed. The reference image is determined for each image capturing apparatus 10 in step S404.

In step S408, the position correction unit 305 corrects the position of the feature detected in step S406 based on the information indicating shake in the image capturing apparatus 10 obtained in step S407. In the present embodiment, the position correction unit 305 corrects the coordinates of the detected position of the feature by applying the transformation parameters to the coordinates of the detected position of the feature. Through this processing, the position correction unit 305 can obtain the estimated position of the feature in the captured image obtained when the image capturing apparatus 10 is in the reference pose.

The processing of steps S406 to S408 is performed on the plurality of captured images obtained by the plurality of image capturing apparatuses 10 capturing images of the feature in synchronization. In this manner, the position information indicating the position of the feature in the field of view of each of the plurality of image capturing apparatuses 10 in the corresponding reference pose, at the timing of each of the plurality of instances of synchronized image capturing, can be obtained. As described above, the correction processing for reducing the influence of shake in the image capturing apparatus 10 is performed on this position information, based on the information indicating shake in the image capturing apparatus 10. In addition, such processing is performed on the plurality of captured images obtained through each of a plurality of instances of synchronized image capturing. In this manner, the position information indicating the position of the feature in the field of view of each of the plurality of image capturing apparatuses 10 in the corresponding reference pose can be obtained for the feature at each of different positions.

In step S409, the calculation unit 306 calculates the camera parameters of the plurality of image capturing apparatuses 10 based on the position information indicating the position of the feature in the field of view of the image capturing apparatus 10, for each of the plurality of image capturing apparatuses 10. In the present embodiment, the calculation unit 306 calculates the camera parameters of the plurality of image capturing apparatuses 10 based on the position information of the feature at each of the timings of the plurality of instances of synchronized image capturing. The position information indicates the position of the feature after the correction in step S408. The camera parameters calculated in step S409 indicate the reference pose of the image capturing apparatus 10 corresponding to the reference image selected in step S404. The position of the feature is corrected in step S408, and thus the influence of shake in the image capturing apparatus 10 on the position and orientation of the image capturing apparatus 10 calculated in step S409 is reduced.

The calibration method used by the calculation unit 306 for calculating the camera parameters is not limited. For example, the calculation unit 306 can calculate the camera parameters using the PnP method, as described in Japanese Patent Laid-Open No. 2019-190974. Specifically, the calculation unit 306 can estimate a fundamental matrix between two image capturing apparatuses 10 based on the detected position of each of a plurality of features after the position correction, from captured images captured by the two image capturing apparatuses 10. The calculation unit 306 can further estimate the positions and orientations of the two image capturing apparatuses 10 based on the fundamental matrix. The calculation unit 306 can further estimate three-dimensional coordinates of each feature based on the results of estimating the positions and orientations of the two image capturing apparatuses 10. The calculation unit 306 can then estimate the position and orientation of another image capturing apparatus based on the detected position of each of a plurality of features after the position correction, and the three-dimensional coordinates of each feature, from the captured images captured by the stated image capturing apparatuses. Note that the calculation unit 306 may perform fine adjustment (bundle adjustment) of the three-dimensional coordinates of the features during the processing. The calculation unit 306 may also select the two image capturing apparatuses 10, or select features referred to for calculating the camera parameters, in accordance with the RANSAC method.

In step S410, the output unit 307 transmits the camera parameters calculated in step S409 to the modeling apparatus 40. The output unit 307 also transmits the reference image selected in step S404 to the image capturing apparatus 10.

Note that in the virtual viewpoint image shooting mode, the image capturing apparatus 10 can use a shake reduction mechanism. For example, in the virtual viewpoint image shooting mode, the correction unit 130 of the image capturing apparatus 10 corrects the captured image captured by the image capturing unit 110 based on the reference image supplied from the calibration apparatus 30. For example, the correction unit 130 can calculate the transformation parameters for aligning the captured image and the reference image through processing similar to that of step S407. Furthermore, the captured image can be corrected by performing transform processing on the captured image in accordance with the transformation parameters. The corrected captured image corresponds to the captured image captured by the image capturing apparatus 10 in the reference pose. As described above, the camera parameters are calculated to indicate the reference pose of the image capturing apparatus 10. Accordingly, even if the image capturing apparatus 10 is shaking when capturing images for generating a virtual viewpoint image, captured images that would be captured by the image capturing apparatus 10 in a pose corresponding to the camera parameters can be obtained from the captured images actually obtained by the image capturing unit 110.

An example of a method for generating information indicating shake in the image capturing apparatus 10, performed by the shake estimation unit 302, will be described next with reference to FIG. 5. However, the method for generating the information indicating shake in the image capturing apparatus 10 is not limited to the following method. The shake estimation unit 302 can use another method to estimate shake in the image capturing apparatus 10 based on an image.

In step S501, the shake estimation unit 302 obtains the reference image. As described above, in step S403 performed prior to selecting the reference image, the shake estimation unit 302 can use the first reference image candidate as the reference image. In step S501, the shake estimation unit 302 obtains the reference image selected in step S404.

In step S502, the shake estimation unit 302 divides the reference image into a plurality of divided regions. For example, the shake estimation unit 302 can divide the reference image into a plurality of rectangular regions. The size of the divided regions can be set in advance. For example, the reference image can be divided in each of the vertical direction and the horizontal direction into between 10 and 40 divisions to improve the robustness and accuracy of the association of the divided regions. For example, the shake estimation unit 302 can divide the reference image into a grid such that about 20 rectangular regions are arranged in the vertical direction and the horizontal direction. As will be described later, shake can be robustly and accurately estimated by associating images in each of the plurality of divided regions.

In step S503, the shake estimation unit 302 calculates a gradient of the reference image. For example, the shake estimation unit 302 can calculate the direction and magnitude of the gradient. For example, the shake estimation unit 302 can calculate the gradient by calculating the difference in brightness between each pixel in the image and the pixels surrounding that pixel. Additionally, the shake estimation unit 302 may perform edge extraction based on the result of calculating the gradient. The specific method is not particularly limited. The shake estimation unit 302 can calculate the gradient of the reference image and perform the edge extraction using the Canny method, for example.

In step S504, the shake estimation unit 302 classifies the plurality of divided regions obtained in step S502 into a plurality of types. For example, the shake estimation unit 302 can classify the plurality of divided regions into a plurality of types including at least a first type and a second type. In step S506, shift between images is evaluated through different methods for divided regions of different types.

In the present embodiment, the shake estimation unit 302 classifies the plurality of divided regions based on the result of detecting the image gradient. For example, the shake estimation unit 302 can classify each divided region into a one-dimensional matching region or a two-dimensional matching region based on the gradient information calculated in step S503. In a divided region in which there is a gradient in only one direction, e.g., a divided region in which only a single line appears, matching between the images can be achieved even if the images are shifted parallel to that line. Accordingly, the shift between images that can be detected in such divided regions is shift in a direction perpendicular to the line. Accordingly, in the present embodiment, if gradient information in a divided region indicates an image gradient in the one-dimensional direction, the divided region can be classified as a one-dimensional matching region. On the other hand, if the gradient information in a divided region indicates a gradient in a two-dimensional direction (including a gradient in a multi-dimensional direction), the divided region can be classified as a two-dimensional matching region.

The method by which the shake estimation unit 302 classifies the divided region is not limited. For example, the shake estimation unit 302 can make the determination using a Hough transform. A specific example will be described hereinafter. For example, the shake estimation unit 302 can detect a straight edge in the divided region by performing a Hough transform on the edge detection result. Here, if only one straight edge of a strength that is at least a threshold is detected, the shake estimation unit 302 can determine that the divided region is a one-dimensional matching region. Here, the strength of the straight edge can be expressed by the number of plots on the Hough space. However, if at least two straight edges of a strength that is at least the threshold are detected, the shake estimation unit 302 can determine that the divided region is a two-dimensional matching region. Note that the shake estimation unit 302 may exclude, from the matching search in step S506, a divided region in which a straight edge of a strength that is at least the threshold is not detected.

In step S505, the shake estimation unit 302 obtains the captured image to be processed. In step S403, the shake estimation unit 302 can obtain the reference image candidate as the image to be processed. In step S505, the shake estimation unit 302 can obtain one of the captured images obtained by the image capturing apparatus 10 in step S405.

In step S506, the shake estimation unit 302 divides the captured image obtained in step S505 into a plurality of divided regions using the same method as in step S502. The shake estimation unit 302 then performs the matching search between the one divided region in the reference image and the divided region at the same position in the captured image. For example, the shake estimation unit 302 can calculate shift between the reference image and the captured image for each divided region. The method for calculating the shift is not particularly limited. In the present embodiment, the shake estimation unit 302 evaluates the shift through a first method for the divided regions of the first type. The shake estimation unit 302 evaluates the shift through a second method different from the first method for divided regions of the second type. Specifically, for the one-dimensional matching region, the shake estimation unit 302 can evaluate shift in the image in a one-dimensional direction. In particular, for the one-dimensional matching region, the shake estimation unit 302 can evaluate shift in a direction orthogonal to the detected feature. If one straight edge is detected from the divided region, the shake estimation unit 302 can evaluate shift in a direction orthogonal to that straight edge. For the two-dimensional matching region, the shake estimation unit 302 can evaluate shift in the image in a two-dimensional direction. For example, for the two-dimensional matching region, the shake estimation unit 302 can evaluate shift in the image in an x direction and a y direction.

For example, the shake estimation unit 302 can repeatedly calculate a cross-correlation between a divided region of interest in the reference image and the corresponding divided region in the captured image while shifting the relative positions of the images. Here, for the one-dimensional matching region, the shake estimation unit 302 can shift the relative positions of the images in a one-dimensional direction. Specifically, the shake estimation unit 302 can shift the relative positions of the images in a direction orthogonal to the straight edge detected from the divided region. For the two-dimensional matching region, the shake estimation unit 302 can shift the relative positions of the images in a two-dimensional direction (for example, in each of the x direction and the y direction). The shake estimation unit 302 can then determine the amount of shift that gives a maximum correlation value as the shift amount between the reference image and the captured image.

In step S507, the shake estimation unit 302 generates the information indicating shake in the image capturing apparatus 10 based on the matching relationship obtained in step S506. In the present embodiment, the shake estimation unit 302 calculates a homography transform between the captured image and the reference image. The shake estimation unit 302 can calculate the homography transform that transforms the reference image into the captured image based on the amount of shift in each divided region, obtained in step S506.

The specific method for calculating the homography transform is not particularly limited. For example, the shake estimation unit 302 can calculate coordinates obtained after shifting the coordinates of the center point of each divided region according to the amount of shift in each divided region. The shake estimation unit 302 can then calculate a homography matrix that transforms pre-shift coordinates into post-shift coordinates using the least-squares method.

The influence of a translation component of the shake in the image capturing apparatus 10 on the captured image is smaller than the influence of a rotation component of the shake in the image capturing apparatus 10 on the captured image. Accordingly, the shake estimation unit 302 can generate the information indicating the shake in the image capturing apparatus 10 to indicate the change in the orientation of the image capturing apparatus 10 and not the change in the position of the image capturing apparatus 10. For example, the shake estimation unit 302 can calculate a homography transform that indicates only a change in the orientation (rotation) of the image capturing apparatus 10, but not a change in the position (translation) of the image capturing apparatus 10. The homography transform can be expressed using an internal parameter matrix and a rotation matrix of the image capturing apparatus 10. The shake estimation unit 302 can therefore calculate the rotation matrix using the least-squares method such that the homography transform transforms the pre-shift coordinates into the post-shift coordinates.

As another method, the shake estimation unit 302 may optimize the parameters of the homography transform. For example, the shake estimation unit 302 may repeat the calculation of the shift in step S506 and the adjustment of the parameters of the homography transform in step S507. In this case, in step S506, the shake estimation unit 302 can apply the homography transform calculated in step S507 to the captured image. The shake estimation unit 302 can then calculate shift between the reference image and the post-transform captured image for each divided region. Furthermore, the shake estimation unit 302 can evaluate error in the homography transform, i.e., error in the determined shake in the image capturing apparatus 10, based on the shift between the reference image and the captured image calculated for each divided region. At this time, the shake estimation unit 302 can evaluate the error in the homography transform based on the amount of shift in a direction orthogonal to the feature in the one-dimensional matching region and the amount of shift in the two-dimensional direction in the two-dimensional matching region. For example, the error in the homography transform may be the sum of these shift amounts for each divided region. The shake estimation unit 302 can repeat steps S506 and S507 a predetermined number of times or as long as the error decreases. Additionally, the shake estimation unit 302 may optimize the parameters of the homography transform using the RANSAC method.

In this manner, the information indicating shake in the image capturing apparatus 10, corresponding to the captured image obtained in step S505, is calculated.

According to the present embodiment described above, even if the image capturing apparatus 10 is shaken during image capturing for calibration, the position of the feature in the field of view of the image capturing apparatus 10, in which the influence of the shake in the image capturing apparatus 10 is reduced, is determined based on the information indicating the shake in the image capturing apparatus 10. This makes it possible to calculate the camera parameters through highly-accurate calibration. Accordingly, a highly-accurate virtual viewpoint image can be generated.

Furthermore, when an image for calibration is captured using the image capturing apparatus 10 while the feature moves in the shooting target area 2, the image capturing apparatus 10 may continue to shake while the feature is moving through a given region. In the present embodiment, the calibration can be performed using captured images captured when the image capturing apparatus 10 is shaking. In other words, it is not necessary to exclude captured images captured by an image capturing apparatus 10 that is shaking when the feature is moving through a given region from the images used for calibration. In this manner, in the present embodiment, the calibration can be performed using captured images obtained when the feature is present at various positions, which makes it possible to calibrate the image capturing apparatus 10 with a higher level of accuracy.

A marker is used as the feature for calibration in the embodiment described above. However, a natural image feature such as SIFT or SURF may be used as the feature. In this case, processing for identifying each feature is performed by associating the features detected by each of the plurality of image capturing apparatuses 10. Such processing can be performed by the feature detection unit 304 or the calculation unit 306. Additionally, a natural image feature and a marker may be used in combination as the feature for calibration.

In the foregoing embodiment, the calibration apparatus 30 determines the reference image for each of the image capturing apparatuses 10. However, the shake estimation unit 302 and the image selection unit 303 perform independent processing for each of the image capturing apparatuses 10. Accordingly, a processing unit included in the image capturing apparatus 10 may perform the processing for determining the reference image.

In the foregoing embodiment, the feature detection unit 304 detects the feature from the captured image, and the position correction unit 305 corrects the position of the detected feature based on the information indicating shake in the image capturing apparatus 10. However, the method for generating position information indicating the position of the feature in the field of view of the image capturing apparatus 10, in which the influence of shake in the image capturing apparatus 10 is reduced, is not limited to this method. For example, the captured image may be transformed before the feature is detected from the captured image.

FIG. 6 is a diagram illustrating an example of the functional configuration of the calibration apparatus 30 in such a configuration. Compared to the calibration apparatus 30 illustrated in FIG. 3, an image transform unit 310 is provided instead of the position correction unit 305. In this embodiment, the image transform unit 310 transforms the captured image based on the information indicating shake in the image capturing apparatus 10. For example, the image transform unit 310 can apply, to the captured image, the inverse transform of the homography transform that transforms the reference image into the captured image. In this manner, the image transform unit 310 can transform a captured image into a captured image that would be obtained when the image capturing apparatus 10 is in the reference pose. The influence of shake in the image capturing apparatus 10 is reduced in the captured image obtained in this manner. The feature detection unit 304 then detects the feature from the image transformed by the image transform unit 310, instead of detecting the feature in the captured image supplied from the image obtainment unit 301. The functions of the other processing units are as described above.

One embodiment of the present disclosure makes it possible to calibrate an image capturing apparatus with a higher level of accuracy, even when the image capturing apparatus shakes during calibration of the image capturing apparatus.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-053750, filed March 27, 2025, which is hereby incorporated by reference herein in its entirety.

What is claimed is:

1. An information processing apparatus comprising one or more memories storing instructions and one or more processors that execute the instructions to:
obtain a captured image of a feature captured by an image capturing apparatus;
generate information indicating shake in the image capturing apparatus, the shake being estimated based on the captured image;
generate, based on the captured image and the information indicating the shake in the image capturing apparatus, position information indicating a position of the feature in a field of view of the image capturing apparatus, an influence of the shake in the image capturing apparatus being reduced in the position information; and
calculate, for each of a plurality of image capturing apparatuses, a camera parameter of the image capturing apparatus based on the position information indicating the position of the feature for the image capturing apparatus.

2. The information processing apparatus according to claim 1,
wherein the one or more processors execute the instructions to detect the feature from the captured image, and correct, based on the information indicating the shake in the image capturing apparatus, a position of the detected feature.

3. The information processing apparatus according to claim 1,
wherein the one or more processors execute the instructions to transform the captured image based on the information indicating the shake in the image capturing apparatus, and detect the feature from the transformed captured image.

4. The information processing apparatus according to claim 1,
wherein the one or more processors execute the instructions to generate the information indicating the shake in the image capturing apparatus based on a comparison of images captured by the image capturing apparatus.

5. The information processing apparatus according to claim 1,
wherein the position information indicates the position of the feature in the field of view when the image capturing apparatus is in a reference pose.

6. The information processing apparatus according to claim 5,
wherein the one or more processors execute the instructions to generate the information indicating the shake in the image capturing apparatus based on a comparison of a reference image with the captured image, the reference image being an image captured by the image capturing apparatus in the reference pose.

7. The information processing apparatus according to claim 6,
wherein the information indicating the shake in the image capturing apparatus is a parameter of a homography transform between the captured image and the reference image.

8. The information processing apparatus according to claim 6,
wherein the one or more processors execute the instructions to estimate the shake in the image capturing apparatus based on shift between the reference image and the captured image, the shift being evaluated for each of a plurality of divided regions.

9. The information processing apparatus according to claim 8,
wherein the one or more processors execute the instructions to:
classify the plurality of divided regions into a plurality of types including at least a first type and a second type; and
evaluate the shift through a first method for a divided region of the first type among the plurality of divided regions, and evaluate the shift through a second method different from the first method for a divided region of the second type among the plurality of divided regions.

10. The information processing apparatus according to claim 9,
wherein the divided region of the first type is a divided region having an image gradient in a one-dimensional direction,
the divided region of the second type is a divided region having an image gradient in a two-dimensional direction,
the first method is a method that evaluates shift in an image in the one-dimensional direction, and
the second method is a method that evaluates shift in an image in the two-dimensional direction.

11. The information processing apparatus according to claim 6,
wherein the one or more processors execute the instructions to determine the reference image from a plurality of images captured by one of the image capturing apparatuses, based on the information indicating the shake in the one image capturing apparatus estimated based on each of the plurality of images.

12. The information processing apparatus according to claim 11,
wherein the one or more processors execute the instructions to select, as the reference image, a captured image captured by the one image capturing apparatus when a pose of the one image capturing apparatus is closer to a center of the shake in the image capturing apparatus estimated using each of the plurality of images.

13. The information processing apparatus according to claim 6,
wherein the one or more processors execute the instructions to output the reference image to the image capturing apparatus.

14. The information processing apparatus according to claim 1,
wherein the one or more processors execute the instructions to:
obtain captured images of the feature obtained through synchronized capturing by the plurality of image capturing apparatuses at each of a plurality of timings at which the position of the feature is different;
generate the position information of the feature for each of the plurality of image capturing apparatuses at each of the plurality of timings; and
calculate the camera parameter of each of the plurality of image capturing apparatuses based on the position information of the feature at each of the plurality of timings for each of the plurality of image capturing apparatuses.

15. The information processing apparatus according to claim 1,
wherein the information indicating the shake in the image capturing apparatus indicates a change in an orientation of the image capturing apparatus and does not indicate a change in a position of the image capturing apparatus.

16. The information processing apparatus according to claim 1,
wherein the camera parameter includes at least one of an external parameter indicating a position and an orientation of the image capturing apparatus, an internal parameter indicating a focal length or an image center of the image capturing apparatus, and a distortion parameter.

17. An information processing system comprising:
an information processing apparatus comprising one or more memories storing instructions and one or more processors that execute the instructions to:
obtain a captured image of a feature captured by an image capturing apparatus;
generate information indicating shake in the image capturing apparatus, the shake being estimated based on the captured image;
generate, based on the captured image and the information indicating the shake in the image capturing apparatus, position information indicating a position of the feature in a field of view of the image capturing apparatus, an influence of the shake in the image capturing apparatus being reduced in the position information; and
calculate, for each of a plurality of image capturing apparatuses, a camera parameter of the image capturing apparatus based on the position information indicating the position of the feature for the image capturing apparatus; and
an image capturing apparatus,
wherein the image capturing apparatus includes:
an image sensor configured to capture a captured image; and
one or more processors configured to execute instructions stored in one or more memories to correct the captured image captured by the image sensor to reduce an influence of shake in the image capturing apparatus.

18. The information processing system according to claim 17,
wherein the one or more processors of the information processing apparatus execute the instructions to generate the information indicating the shake in the image capturing apparatus based on a comparison of a reference image with a captured image, the reference image being an image captured by the image capturing apparatus in a reference pose, and
the one or more processors of the image capturing apparatus execute the instructions to correct the captured image based on a comparison with the reference image, the reference image being supplied from the information processing apparatus.

19. A method of controlling an information processing apparatus, comprising:
obtaining a captured image of a feature captured by an image capturing apparatus;
generating information indicating shake in the image capturing apparatus, the shake being estimated based on the captured image;
generating, based on the captured image and the information indicating the shake in the image capturing apparatus, position information indicating a position of the feature in a field of view of the image capturing apparatus, an influence of the shake in the image capturing apparatus being reduced in the position information; and
calculating, for each of a plurality of image capturing apparatuses, a camera parameter of the image capturing apparatus based on the position information indicating the position of the feature for the image capturing apparatus.

20. A non-transitory computer-readable medium storing a program executable by a computer to perform a method comprising:
obtaining a captured image of a feature captured by an image capturing apparatus;
generating information indicating shake in the image capturing apparatus, the shake being estimated based on the captured image;
generating, based on the captured image and the information indicating the shake in the image capturing apparatus, position information indicating a position of the feature in a field of view of the image capturing apparatus, an influence of the shake in the image capturing apparatus being reduced in the position information; and
calculating, for each of a plurality of image capturing apparatuses, a camera parameter of the image capturing apparatus based on the position information indicating the position of the feature for the image capturing apparatus.
